(19) United States
(12) Patent Application Publication
(10) Pub. No.: US 2012/0218226 A1
(43) Pub. Date: Aug. 30, 2012

(54) LIGHT DIRECTING ELEMENT AND INFRARED TOUCH SCREEN DEVICE HAVING SAME

(75) Inventors: HAN-CHE WANG, Tu-Cheng (TW); GWO-YAN HUANG, Tu-Cheng (TW); KUN-CHIH HSIEH, Tu-Cheng (TW); WEN-HSING LIN, Tu-Cheng (TW); MING LI, Shenzhen City (CN); KUAN-HONG HSIEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/206,531

(22) Filed: Aug. 10, 2011

(30) Foreign Application Priority Data
Feb. 28, 2011 (CN) 201110047864.5

(51) Int. Cl. G06F 3/042

(52) U.S. Cl. 345/175

(57) ABSTRACT

A light directing member for an infrared touch screen device is provided. The infrared touch screen includes a touch screen having a first side and an opposing second side, an infrared emitter for emitting infrared light beams toward the light directing element, and a plurality of infrared receivers arranged along the first side of the touch screen. The light directing member is positioned at the second side of the touch screen, and includes an outwardly curved surface facing the infrared emitter and a plurality of reflective slanted surfaces. The curved surface collimates the infrared light beams emitted from the infrared emitter into parallel infrared light beams. The plurality of reflective slanted surfaces are aligned with the respective infrared receivers, and for receiving and reflecting corresponding portions of the collimated parallel beams to the respective infrared receivers. A related device is also provided.

### BACKGROUND

1. Technical Field

The present disclosure relates to photoelectric devices, and particularly, to a light directing element and an infrared touch screen device having the same.

2. Description of the Related Art

An infrared touch panel often includes a circuit board having a first pair of opposite sides positioned parallel to a first axis and a second pair of opposite sides positioned parallel to a second axis perpendicular to the first axis. The four sides corporately define a generally rectangular touch input area. A linear array of light emitting devices is arranged along each side. A light detection device is positioned at each corner of the circuit board. A controller is coupled to the light emitting devices and the light detection devices. The controller sequentially activates each linear array and activates the light detection devices positioned at the corners of the circuit board opposed to the activated array of light emitting devices. One problem with device using such an infrared touch panel is that there are many light emitting devices and light detection devices, thus increasing costs. A plurality of optical elements, such as mirrors, are used to reduce the numbers of the light emitting devices and light detection devices, but the uniformity and the intensity of the light reflected by the optical elements is deadened.

Therefore, there is room for improvement within the art.

### BRIEF DESCRIPTION OF THE DRAWINGS

The components in the drawings are not necessarily drawn to scale, the emphasis instead being placed upon clearly illustrating the principles of a light directing element and an infrared touch screen device having the same. Moreover, in the drawings, like reference numerals designate corresponding parts throughout the several views.

FIG. 1 is an isometric view of an infrared touch screen having a light directing element in accordance with an exemplary embodiment.

FIG. 2 is an isometric view of an infrared touch screen having a light directing element in accordance with another exemplary embodiment.

FIG. 3 is an isometric view of the infrared touch screen having two light directing elements of FIG. 1, which are perpendicular to each another.

FIG. 4 an isometric view of the infrared touch screen having two light directing elements of FIG. 2, which are perpendicular to each another.

### DETAILED DESCRIPTION

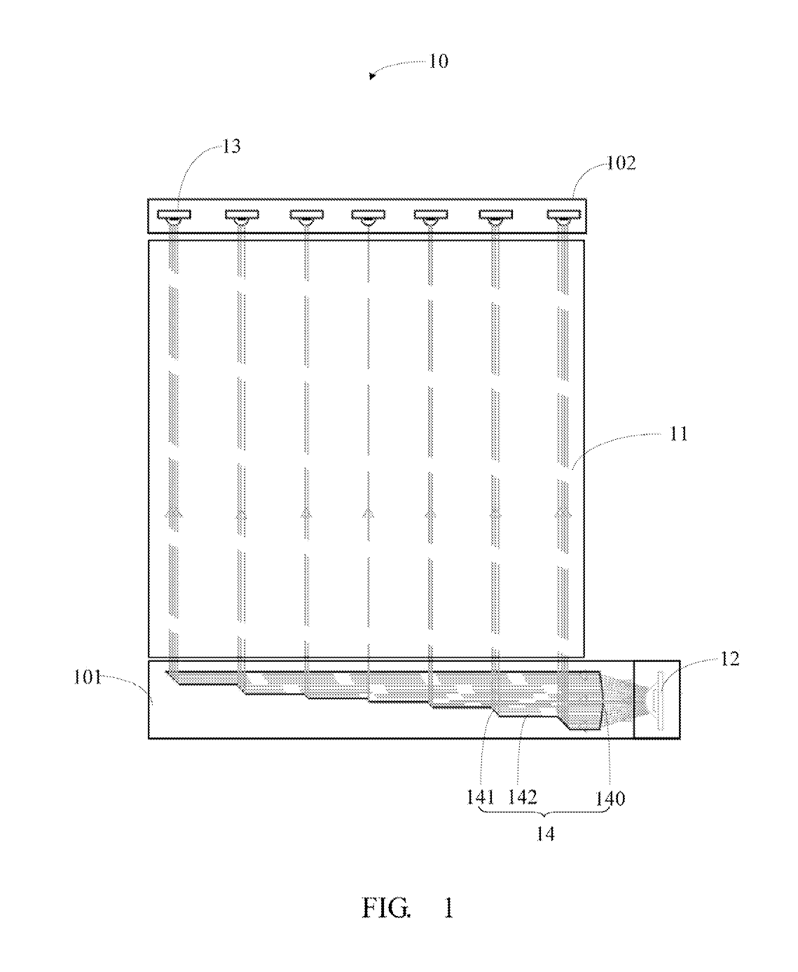

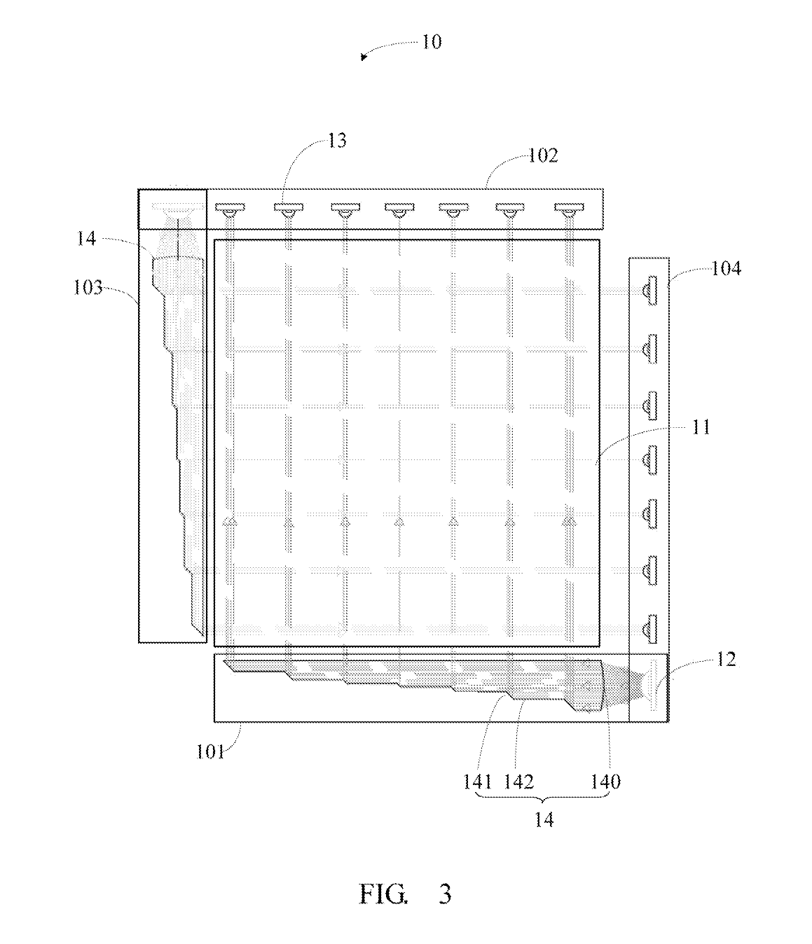

Referring to FIGS. 1 and 3, an infrared touch screen device 10 is provided. The infrared touch screen device 10 includes a touch screen 11 having a first pair of opposite, parallel sides 101 and 102, and a second pair of opposite, parallel sides 103 and 104, an infrared emitter 12 and a plurality of infrared receivers 13. The device 10 further includes at least one light directing element 14. The infrared emitter 12 is configured for emitting infrared light beams toward the light directing element 14. Referring to FIG. 1, the plurality of infrared receivers 13 are arranged along the side 102 of the touch screen 11. The light directing element 14 is positioned at the side 101 of the touch screen 11. The light directing element 14 includes an outwardly curved surface 140 facing the infrared emitter 12, and a plurality of reflective slanted surfaces 141. The number of the plurality of infrared receivers 13 is not limited and can be varied according to need. For example, there may be only one infrared receiver 14 in some specific conditions.

In this embodiment, the light directing element 14 extends along the side 101, and the infrared emitter 13 is positioned adjacent to the curved surface 140 of the light directing element 14. The infrared emitter 12 is arranged in a manner such that light paths of the infrared light beams emitted therefrom between the infrared emitter 12 and the outwardly curved surface 140 of the light directing element 14 are located outside the touch screen 100. The outwardly curved surface 140 is configured to collimate the infrared light beams emitted from the infrared emitter 12 into parallel infrared light beams. The plurality of reflective slanted surfaces 141 are aligned with the respective infrared receiver 13, configured to receive and reflect corresponding portions of the collimated parallel beams to the respective infrared receiver 13. In the embodiment, the number of reflective slanted surfaces 141 is equal to the number of the infrared receivers 13.

The reflective slanted surfaces 141 are spaced from each other and parallel to each other. In this embodiment, the light directing element 14 is a light guide. The light directing element 14 further includes a plurality of step surfaces 142, and interconnected between the plurality of reflective slanted surfaces 141.

Because the intensity of the divergent beams emitted by the infrared emitter 12 decreases gradually from the center to the periphery of the divergent beams. In the embodiment, the reflective slanted surfaces 141 are arranged in such a manner to reflect the central portion of the light beams (hereinafter “central reflective slanted surfaces 141”) having the smallest size. So that the sizes of the other reflective slanted surfaces 141 at the opposite sides increases gradually from the size of the central reflective slanted surfaces 141. As a result, each infrared receiver 13 receives substantially the same intensity of light beams, thereby allowing the touch screen 11 to have substantially the same touch sensitivity.

In a second embodiment, because of principle of the reversibility of the light path, the infrared receivers 13 arranged at the side 102 are replaced by the same number of infrared emitters 12. The infrared emitter 12 arranged at the side 101 is replaced by an infrared receiver 13.

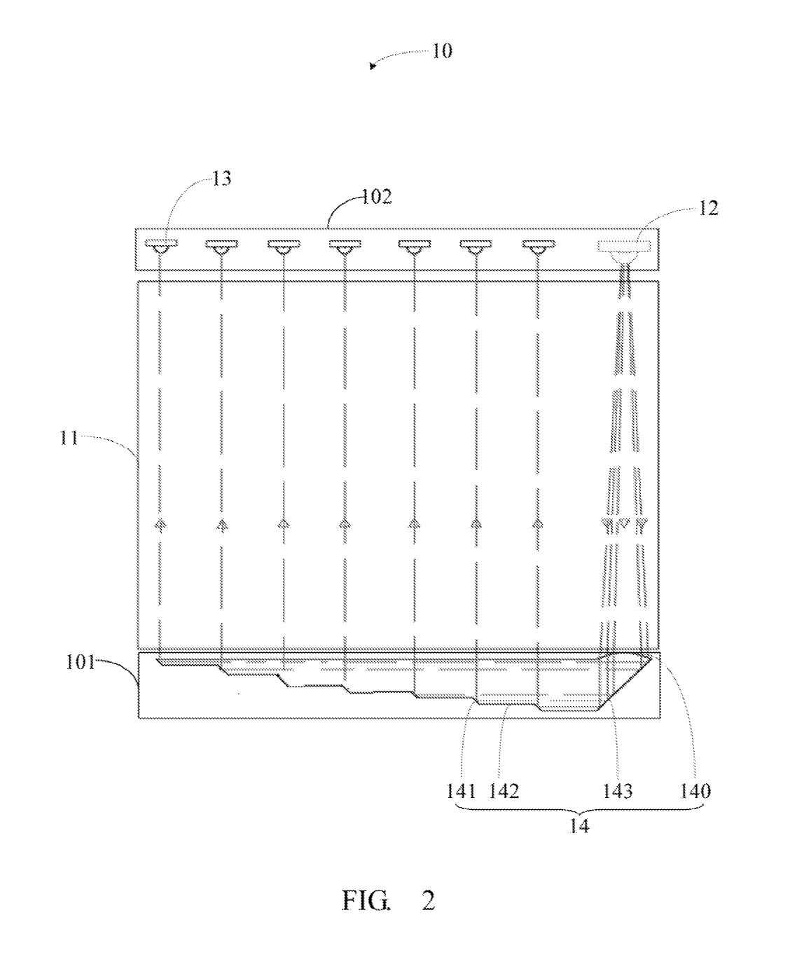

Referring to FIG. 2, in a third embodiment, the infrared touch screen device 10 includes the light directing element 14 disposed at the side 101, the infrared emitter 12 and the plurality of infrared receivers 13 arranged at the side 102. The infrared emitter 12 is configured for emitting the infrared beams along a direction substantially perpendicular to the parallel infrared light beams. The outwardly curved surface 140 of the light directing element 14 is collimate the infrared light beams emitted from the infrared emitter 12 into parallel infrared light beams. The light directing element 14 further includes a light reflecting surface 143, and configured for reflecting the collimated infrared light beams to the reflective slanted surfaces 141. The infrared light beams reflected by the light reflecting surface 143 then can be reflected by the plurality of reflective slanted surfaces 141 to the infrared receivers 13.

In a fourth embodiment, because of principle of the reversibility of the light path, the infrared receivers 13 arranged at the side 102 are replaced by the same number of infrared emitters 12, and the infrared emitters 12 arranged at the side 101 are replaced by an infrared receivers 13.

FIG. 3 shows an infrared touch display 10 similar to the infrared touch display 10 as shown in FIG. 1, but further including an additional light directing element 14, an additional infrared emitter 12, and an additional plurality of infrared receivers 13. In this embodiment, the additional light directing element 14 has the same structure as the light directing element 14 shown in FIG. 1 and includes an outwardly curved surface 140, a plurality of reflective slanted surfaces 141, and a plurality of step surfaces 142. The light directing element 14 is positioned at the side 103, and the infrared emitter 12 and the plurality of infrared receivers 13 are arranged at the side 104.

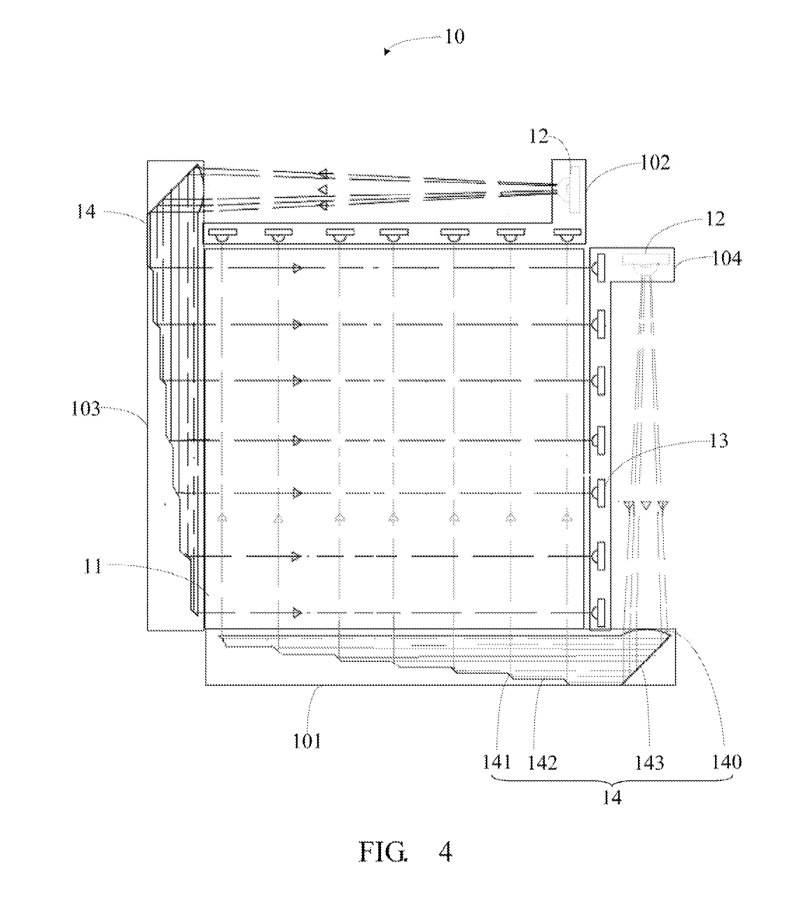

FIG. 4 shows an infrared touch screen device 10 similar to the infrared touch screen device as shown in FIG. 2, but further including an additional light directing element 14, an additional infrared emitter 12, and an additional plurality of receivers 13. In this embodiment, the additional light directing element 14 has the same structure as the light directing element 14 as shown in FIG. 2, and includes an outwardly curved surface 140, a plurality of reflective slanted surfaces 141, a plurality of step surfaces 142, and a light reflecting surface 143. The light directing element 14 is arranged at the side 103. The infrared emitter 12 and the plurality of infrared receivers 13 are arranged at the side 104, the infrared emitter 12 is positioned behind the infrared receiver 13 arranged at the corner between the sides 102 and 104, and facing to the outwardly curved surface 140 arranged at the side 103. The infrared emitter 12 and the plurality of infrared receivers 13 are arranged at the side 102, the infrared emitter 12 is positioned behind the infrared receiver 13 arranged at the corner between the sides 102 and 104, and facing the outwardly curved surface 140 arranged at the side 101.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An infrared touch screen device comprising:
a touch screen having a first side and an opposing second side;
an infrared emitter;
a plurality of infrared receivers arranged along the first side of the touch screen;
a light directing element positioned at the second side of the touch screen, the infrared emitter configured for emitting infrared light beams toward the light directing element, the light directing element comprising:
an outwardly curved surface facing the infrared emitter, the outwardly curved surface configured to collimate the infrared light beams emitted from the infrared emitter into parallel infrared light beams; and
a plurality of reflective slanted surfaces aligned with the respective infrared receivers, the slanted surfaces configured to receive and reflect corresponding portions of the collimated parallel beams to the respective infrared receivers.

2. The infrared touch screen device as recited in claim 1, wherein the infrared emitter is arranged adjacent to the first side of the touch screen, the infrared emitter is configured for emitting the infrared beams along a direction substantially perpendicular to the parallel infrared light beams, and the light directing element comprises a light reflecting surface configured for reflecting the collimated infrared light beams to the reflective slanted surfaces.

3. The optical structure as recited in claim 1, wherein the infrared emitter is arranged adjacent to the second side of the touch screen, and the infrared emitter is configured for emitting the infrared beams along a direction substantially parallel to the collimated infrared light beams.

4. The optical structure as recited in claim 1, wherein the infrared emitter is arranged in a manner such that light paths of the infrared light beams emitted therefrom between the infrared emitter and the outwardly curved surface of the light directing element are located outside the touch screen.

5. A light directing member for an infrared touch screen device, the infrared touch screen comprising a touch screen having a first side and an opposing second side, an infrared emitter configured for emitting infrared light beams toward the light directing element, a plurality of infrared receivers arranged along the first side of the touch screen, the light directing member comprising:
a light directing block configured to be positioned at the second side of the touch screen, the light directing block comprising:
an outwardly curved surface configured for facing the infrared emitter, the outwardly curved surface configured to collimate the infrared light beams emitted from the infrared emitter into parallel infrared light beams; and
a plurality of reflective slanted surfaces configured for aligning with the respective infrared receivers, the slanted surfaces configured to receive and reflect corresponding portions of the collimated parallel beams to the respective infrared receivers.

6. The light directing member as recited in claim 5, wherein the reflective slanted surfaces are spaced from each other and parallel to each other.

7. The light directing member as recited in claim 6, further comprising a plurality of step surfaces interconnected between the reflective slanted surfaces.

8. The light directing member as recited in claim 6, further comprising a light reflecting surface configured for reflecting the collimated infrared light beams to the reflective slanted surfaces.

9. The light directing member as recited in claim 7, wherein the light reflecting surface is perpendicular to the reflective slanted surfaces.
